(19) United States
(12) Patent Application Publication
(10) Pub. No.: US 2014/0180805 A1
(43) Pub. Date: Jun. 26, 2014

(54) Arranging Advertisement Content In Digital Receipts

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/722,968

(22) Filed: Dec. 20, 2012

(51) Int. Cl. G06Q 30/02

(52) U.S. Cl. CPC G06Q 30/0241
USPC 705/14.53; 705/14.4; 705/14.55

(57) ABSTRACT

The present invention extends to methods, systems, and computer program products for arranging advertisement content in digital receipts. A receipt database server formulates a digital receipt for a sales transaction. When the digital receipt is requested for viewing by another computer system, the receipt database server can arrange content in the digital receipt for an advertising purpose. In some embodiments, the digital receipt server places an advertisement insert into the digital receipt. In other embodiments, the digital receipt server (re)arranges receipt items of the digital receipt so that some receipt items appear more prominently (e.g., are moved towards the top of the digital receipt, are displayed in a different color, are highlighted, etc.). Thus, in response to requesting a digital receipt, a customer mobile device can receive an advertisement digital receipt. The advertisement digital receipt can include content arranged for an advertising purpose.

### CROSS-REFERENCE TO RELATED APPLICATIONS

Not applicable.

### BACKGROUND

1. Field of the Invention

This invention relates generally to the field of electronic sales transactions, and, more particularly, to arranging advertisement content in digital receipts.

2. Related Art

In a variety of transactions, consumers or buyers of goods or services typically receive receipts from their respective merchants or service providers as proof of existence of conducted transactions. Generally, receipts are issued by merchants and service providers for a number of reasons including, for example, regulatory or tax reasons and convenience purposes. A receipt provides information about a corresponding transaction for the purpose of providing all participants with a trace or record of the transaction. Receipts can later be used by a consumer for various purposes including, for example, proving participation in a transaction for tax reporting purpose, product returns, use as a claim ticket for a further transaction, provisioning warranties, etc. Depending on a variety of factors, such as, for example, items being purchased, business or personal purchase, amount of purchase, etc., a consumer may desire an electronic receipt and/or a paper receipt.

For in-store purchases, consumers generally obtain a paper receipt at the point-of-sale. However, some point-of-sale systems also support the delivery of digital receipts at the point-of-sale. Further, for telephone or online purchases digital receipts are typically delivered to a customer.

However, receipt deliver mechanisms are somewhat rigid and may not allow a user to configure desired receipt types (e.g., digital and/or paper) for use at checkout. For example, a conventional point-of-sale (“POS”) system typically includes a POS terminal, one or more peripheral devices (display monitor, receipt printer, barcode scanner, weigh scale, electronic signature pad) and a payment processor with pin pad (for credit and debit cards). The data for sales transactions is usually stored in a storage device of the POS terminal, which may be uploaded to one of the remote transaction authorization server or another remote server of the credit/debit card companies. Although POS systems are well equipped for merchants to monitor and collect transaction data from the POS system, the ability of the customer to input or extract useful information from the POS system is typically limited to pinpad interactions (entering tip amounts, obtaining additional cash back, etc.), and obtaining printed receipts, the format and content of which has been pre-determined by the merchant.

Even when digital receipts are generated, the digital receipts may be in a pre-configured format that is not adjustable. For example, digital receipts can be images of paper receipts that are provided to a customer at the POS system. The digital receipts can include a store identifier, a receipt identifier, a date and time of purchase, and various receipt items having item identifiers and item information. The receipt items are typically listed sequentially based on their scan order (i.e., the order the cashier scanned the items). Since the digital receipt is an image file, a customer is limited to viewing receipt items in the same sequential order.

Some POS systems may be capable of generating digital receipts as separate digital data. However, POS systems are typically sold with a proprietary on-board software system that may be specific to the merchant's business. The merchant is able to make minor programming adjustments to add discount codes and other special offers, but has limited ability to add functionality to the POS system. Thus, even if digital receipts are provided as separate digital data, a customer typically has limited, if any, ability to change how a digital receipt is viewed.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates arranging advertisement content into a digital receipt.

FIG. 3 illustrates a flow chart of an example method for inserting advertisement content in a digital receipt.

FIG. 4 illustrates an example of an advertisement digital receipt having inserted advertising content.

FIG. 5 illustrates a flow chart of an example method for rearranging receipt items of a digital receipt for advertising.

FIG. 6 illustrates an example of an advertisement digital receipt having re-arranged receipt items.

FIG. 7 illustrates an example schematic block diagram of a point-of-sale (“POS”) system that creates digital receipts.

FIG. 8 illustrates an example schematic block diagram of a network of point-of-sale (“POS”) systems that creates digital receipts.

### DETAILED DESCRIPTION

The present invention extends to methods, systems, and computer program products for arranging advertisement content in digital receipts. In the following description of the present invention, reference is made to the accompanying drawings, which form a part hereof, and in which is shown by way of illustration specific embodiments in which the invention is may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

It is further noted that, where feasible, functions described herein can be performed in one or more of: hardware, software, firmware, digital components, or analog components. For example, one or more application specific integrated circuits (“ASICs”) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

Embodiments of the invention are directed to arranging advertisement content in digital receipts. When a sales transaction completes, a Point-Of-Sale (“POS”) system sends digital receipt data to a receipt database server. The receipt database server formulates a digital receipt for the sales transaction from the digital receipt data. When the digital receipt is requested for viewing by another computer system, the receipt database server can arrange content in the digital receipt for an advertising purpose.

In general, the digital receipt server generates an advertisement digital receipt from the digital receipt. In some embodiments, the digital receipt server places an advertisement insert into the digital receipt. In other embodiments, the digital receipt server (re)arranges receipt items of the digital receipt so that some receipt items appear more prominently (e.g., are moved towards the top of the digital receipt, are displayed in a different color, are highlighted, etc.). Thus, in response to requesting a digital receipt, a customer mobile device can receive an advertisement digital receipt. The advertisement digital receipt can include content arranged for an advertising purpose.

Advertisers can benefit from providing advertisements to select customers. As such, the receipt database server can refer to criteria to determine when and how to arrange advertising content in a digital receipt. For example, the receipt database server can use the contents of the digital receipt (e.g., purchased items, transaction total, etc.), a customer ID, to determine if it is appropriate to arrange advertising content within the digital receipt.

In general, an advertiser desires keep customers and gain new customers. To efficiently use available resources, advertisers may attempt to match their product with a customer that buys similar or related products. For example, a customer that has purchased coffee and creamer may be a candidate to receive advertisements for a coffee machine. On the other hand, a customer that buys tools and auto parts would not generally be a candidate to receive advertisements for cosmetics.

Accordingly, both mobile device users and product providers can benefit advertising content is arranged within a digital receipt. A customer may receive, as part of the advertisement, a discount on their next purchase of a product. In addition, a customer can become aware of a new product available from a vendor. Advertisement receipts can also include public service announcements, such as, information about a non-profit or an announcement about a local event.

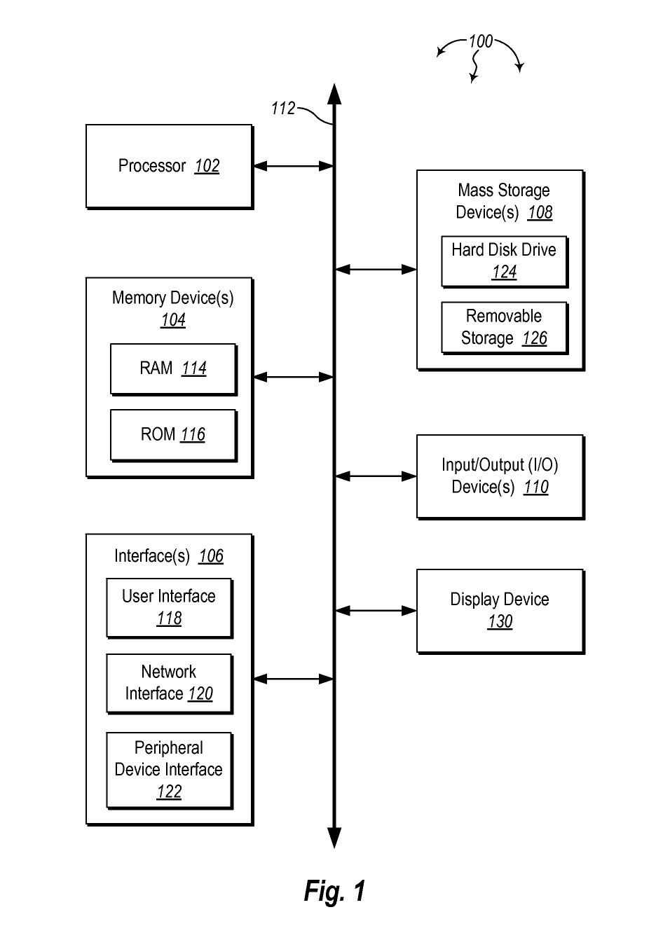

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer-readable media, such as cache memory.

Memory device(s) 104 include various computer-readable media, such as volatile memory (e.g., random access memory (“RAM”) 114) and/or nonvolatile memory (e.g., read-only memory (“ROM”) 116). Memory device(s) 104 may also include rewritable ROM, such as Flash memory.

Mass storage device(s) 108 include various computer readable media, such as magnetic tapes, magnetic disks, optical disks, solid state memory (e.g., Flash memory), and so forth. As shown in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments. Example interface(s) 106 can include any number of different network interfaces 120, such as interfaces to personal area networks (“PANs”), local area networks (“LANs”), wide area networks (“WANs”), wireless networks (e.g., near field communication (“NFC”), Bluetooth, Wi-Fi, etc. networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

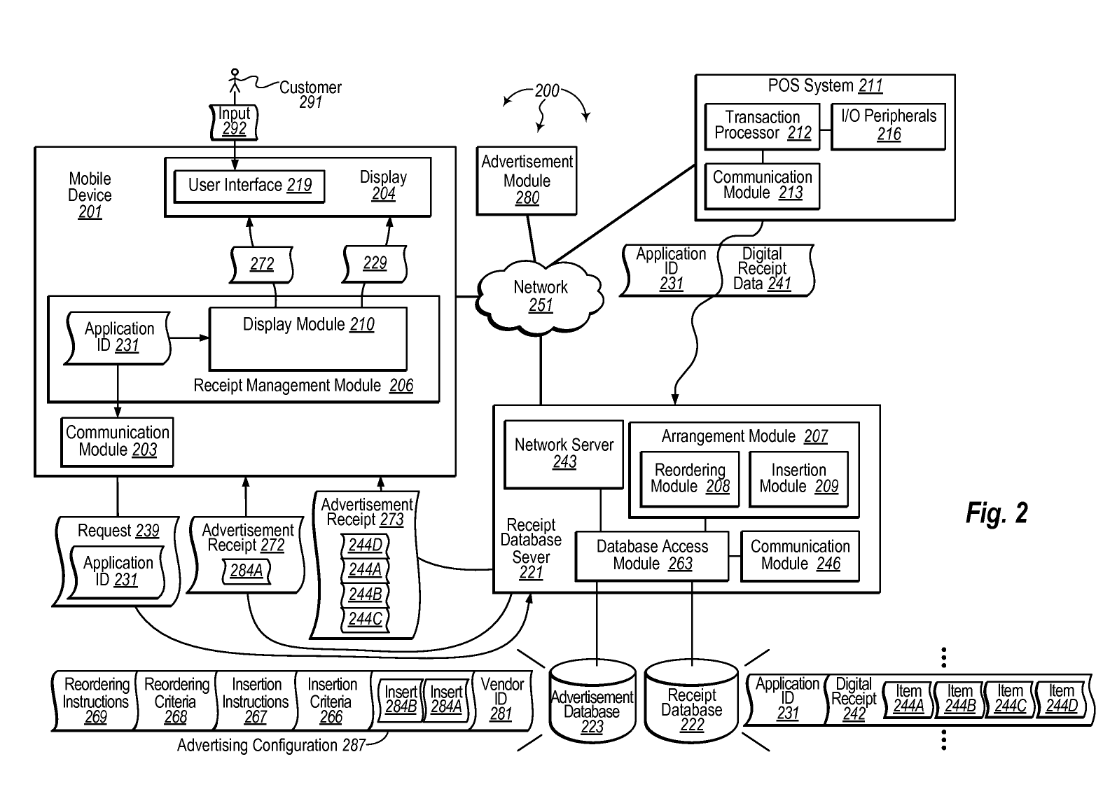

FIG. 2 illustrates an example computer architecture 200 that facilitates arranging advertisement content in digital receipts. Referring to FIG. 2, computer architecture 200 includes mobile device 201, POS system 211, receipt database server 221, and advertisement module 280. Each of the depicted components can be connected to one another over (or be part of) a network, such as, for example, a PAN, a LAN, a WAN, and even the Internet. Accordingly, each of the depicted components as well as any other connected computer systems and their components, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

POS system 211 includes transaction processor 212, communication module 213, and I/O peripherals 216. POS system 211 can be physically located at a checkout lane in a store. Generally, transaction processor 212 is configured to manage sales transactions for POS 211A. Transaction processor 212 can receive input from I/O peripherals 216 to open a sales transaction, collect receipt data (e.g., date, time, item, number of units, cost data, tax, department, etc.) for a sales transaction, and close a sales transaction. Receipt data for an item (e.g. item description, item cost, department, etc.) can be retrieved from an item database in response to scanning a barcode on (or otherwise identifying) the item. Other receipt data for an item (e.g., number of units, tax, etc.) can be calculated by transaction processor 212. I/O peripherals 216 can include one or more of: a monitor (e.g., a cashier-facing monitor), one or more input devices (e.g., scanners, keyboards, scales, or the like), one or more payment devices (e.g., cash drawers, card readers, etc.) for receiving or returning payments, and one or more output devices (e.g., customer-facing display or monitor, receipt printer, etc.).

Communication module 213 can be a wired and/or wireless network adapter for connecting POS system 211 with a network, such as, for example, a Wi-Fi and/or wired Ethernet network, that facilitates a further connection to network 251 (e.g., the Internet).

POS system 211 can be in a physical store location that is owned by an entity, such as, for example, a retailer corporation that runs a chain of stores. The chain of stores can include one or more of: grocery stores, department stores, warehouse stores, discount stores, etc. In embodiments, POS system 211 includes components in a checkout isle as well as components in a store based data center.

One of more other POS systems can also be at the physical store location. Other POS systems for the entity can also be at other physical store locations.

Receipt database server 221 includes arrangement module 207, Network (e.g., Web) server 243, communication module 246, and database access module 263. Network server 243 is configured to communicate with external devices, such as, for example, mobile device 201. A common entity, such as, a retailer corporation, can own one or more physical store locations (e.g., a chain of stores) as well as receipt database server 221. Each of the one or more store physical locations can include one or more POS systems as well as other computer systems (e.g., local backend servers). Communication module 246 can be configured to communicate with POS systems as well as other computer systems at each of the one or more physical store locations (e.g., on an internal corporate network) to facilitate business operations for the entity.

Receipt database server 221 can receive application identifiers and digital receipt data from POS systems at various different store locations, including POS systems 211. For example, receipt database server 221 can receive application ID 231 along with digital receipt data 241. Receipt database server 221 can formulate digital receipts from received receipt data. Formulated digital receipts can include entries for items included in corresponding digital receipt data (but potentially in a different format, for example, a format deliverable to mobile devices). For example, receipt database server 221 can formulate digital receipt 242 from digital receipt data 241.

Database access module 263 can store digital receipts along with application identifiers in receipt database 222. For example, database access module 262 can store digital receipt 242 along with application ID 231. The application identifiers map digital receipts to corresponding mobile devices. For example, application ID 231 can map digital receipt 242 to mobile device 201. Application identifiers can be indicated, either manually by a customer in an automated fashion by a mobile device, at the time of a transaction.

Receipt database server 221 can be part of a (e.g., regional, national, or global) backend system that receives receipt data from a plurality of POS systems distributed throughout different geographic locations and formulates corresponding digital receipts. The plurality of POS systems and the backend system can be part of a commonly owned and/or controlled corporate network infrastructure.

Subsequent to storing digital receipts, receipt database server 221 can send stored digital receipts (e.g., in a created format or (re)arranged to include advertising content) to customer computing devices, such as, for example, smartphones and/or tablets. Receipt database server 221 can send digital receipts to a mobile device in response to a request and/or in accordance with configured settings. For example, in response to a request for receipts from mobile device 201, receipt database server 221 can send any of digital receipt 242, advertising digital receipt 272, or advertising digital receipt 273 to mobile device 201. Sending digital receipts from receipt database server 221 to a mobile device can involve push or polled mechanisms. Receipt database server 221 can send digital receipts in a web or native view.

Advertisers can use advertisement module 280 (or a similar module) to maintain their own advertising configurations in advertisement database 223. The advertisement module 280 can be located within a purchasing department of a store or elsewhere, such as for example, at corporate location, a manufacturer location, etc. As such, an advertiser (e.g., a vendor or retailer) can log in using advertisement module 280 to access their advertising content (stored by vendor ID) stored in advertisement database 223. Advertisement module 280 can include an interface for accessing, adding, deleting, and updating advertising configurations stored in advertisement database 223. Thus, advertisers can create or update advertising content, criteria, instructions, etc. for compatibility with more general advertising campaigns. Permitting advertisers to maintain their own advertising configurations relieves an owner of POS system 211 and receipt database server 211 from having to do so.

Accordingly, receipt database server 221 can receive vendor identifiers and advertisement configuration data from advertisement module 280.

Advertising configurations can include advertisement inserts, insertion criteria, and insertion instructions. Advertisement inserts can include textual data, pictures, other graphics, links to manufactures or vendors websites (e.g., hyperlinks), triggers to launch customer workflows within the application viewing the receipt (e.g., show coupon details or apply coupon to next shop) as well as other such advertisement information that can be inserted into a digital receipt to supplement the content (e.g., receipt items) of the digital receipt. Advertisement inserts may also include public service announcements, messages about a sports team, places to donate for a good cause and other such information. For example, if a local high school sports team is playing for a state championship, a local merchant would generally benefit from placing a statement of support on an advertisement receipt. Advertisement receipts can also show a merchant's support for medical research by indicating where donations can be made cancer research, etc.

Insertion criteria define when an advertisement insert is to be inserted into a digital receipt. Insertion criteria can be configured to target advertisement inserts to customers having an increased possibility of responding to an advertisement insert. Using insertion criteria, a vendor can target an advertisement insert for product to customers who have purchased the product, similar products, related products, or competitor's products, either currently or in the past. For example, a soda manufacturer can target advertisement inserts for soda to digital receipts that include receipt items for a variety of picnic related supplies. Other insertion criteria can limit the number of advertisement inserts allowed, consider dates for advertisement inserts, consider if a customer has opted in for receiving advertisement inserts, consider a total purchase amount (e.g., is the total purchase price above or below a threshold), etc. Limiting the number of inserts can be used to control costs that a manufacturer or vendor may pay for using the receipt as an advertisement media.

Insertion instructions can indicate where and how an advertisement insert is to be placed within a digital receipt. Insertion instructions can be used to insert an advertisement insert when insertion criteria are satisfied. Each time a vendor's advertisement insert is placed into a digital receipt, the owner of POS system 211 and/or receipt database server 221 can receive financial compensation from the vendor.

Insertion instructions can also be used to insert supplemental content into a digital receipt. Supplemental content can adjust the display characteristics of other content already included in a digital receipt. For example, insertion instructions can be used to highlight and/or change the color of an existing receipt item in a digital receipt.

Advertising configurations can include reordering criteria and reordering instructions. Reordering criteria define when receipt items in a digital receipt are to be reordered. Reordering criteria can also be used to target advertising to customers having an increased possibility of responding. Using reordering criteria, a vendor can target receipt item reordering for a product to customers who have purchased the product, similar products, related products, or competitor's products, either currently or in the past. For example, a vendor can target reordering its receipt items to digital receipts including receipt items for its product as well as a competitor's product. Other reordering criteria can limit the number of times a receipt item is reordered, consider if a customer has opted in for receiving advertisements, consider a total purchase amount (e.g., is the total purchase price above or below a threshold), etc.

Reordering instructions can indication how to reorder receipt items within a digital receipt. Reordering instructions can be used to reorder receipt items within a digital receipt when reordering criteria are satisfied. Each time receipt items are reordered to the benefit of a vendor, the owner of POS system 211 and/or receipt database server 221 can receive financial compensation from the vendor.

In some embodiments, insertion instructions and reordering instructions can be used in combination. For example, reordering instructions can move a receipt item closer to the top of a digital receipt and insertion instructions can highlight the receipt item.

Advertising configurations can be product specific and vendor provided. Other advertising configurations can be retailer lead generation advertisements. For example, “people who bought a skateboard also bought knew pads”. Clicking on the kneepads can show all kneepads sold by the retailer.

In some embodiments, receipt database 222 maintains a historical log of digital receipts by a customer or application ID. In these embodiments, insertion criteria can be based on data contained in the historical log. Advertisers can user the historical log to make more refined and/or complex advertising decisions (relative to the content of a single digital receipt). For example, a coffee manufacture may desire to advertise its coffee or reorder receipt items for its coffee on digital receipts for any customer or application ID that has purchased a coffee maker in the last year.

Accordingly, arrangement module 207 is configured to access advertising configurations from advertisement database 223. Arrangement module 207 can refer to advertising configurations to determine when and how advertising content is to be arranged within digital receipts. More specifically, insertion module 209 can process insertion criteria to determine if an advertisement insert is to be inserted into a digital receipt. When insertion criteria are satisfied, insertion module 209 can process insertion instructions to insert an advertisement insert and/or supplemental content into a digital receipt. Reordering module 208 can process reordering criteria to determine if receipt items are to be reordered within a digital receipt. When reordering criteria are satisfied, reordering module 208 can process reordering instructions to reorder receipt items in the digital receipt.

In some embodiments, insertion module 209 and reordering module 208 interoperate to both reorder receipt items within and insert content (e.g., one or more of an advertisement insert and supplemental content) into a digital receipt.

As depicted, mobile device 201 (e.g., a smartphone) includes communication module 203, display 204, and receipt management module 206. In general, receipt management module 206 provides a user of mobile device 201 with various mechanisms for managing their digital receipts. Receipt management module 206 further includes display module 210. Display module 201 is configured to display digital receipts at user-interface 219. Receipt management module 206 can also be used to pair customer application ID 231 (e.g., derived from a loyalty number, a telephone number, a portion of a credit card number, etc.) with mobile device 201. As such, electronic receipts corresponding to application ID 231 can be delivered to mobile device 201.

Receipt management module 206 can present user-interface 219 at display 204 (e.g., a general purpose display device). User-interface 219 can include (e.g., touch screen) user-interface controls allowing a user to interact with digital receipt content (e.g., receipt items, advertisement inserts, etc.) For example, customer 291 can enter input 292 to request a receipt from receipt database server 221. The receipt sent to mobile device 201 can be an advertisement digital receipt including one or more of: advertisement inserts, supplemental content, or reordered receipt items.

Communication module 203 can be a wireless network adapter for connecting mobile device 201 with a wireless network, such as, for example, Wi-Fi and/or a cellular network (e.g., CDMA, GSM, iDen, etc.) that facilitates a further connection to network 251 (e.g., the Internet)

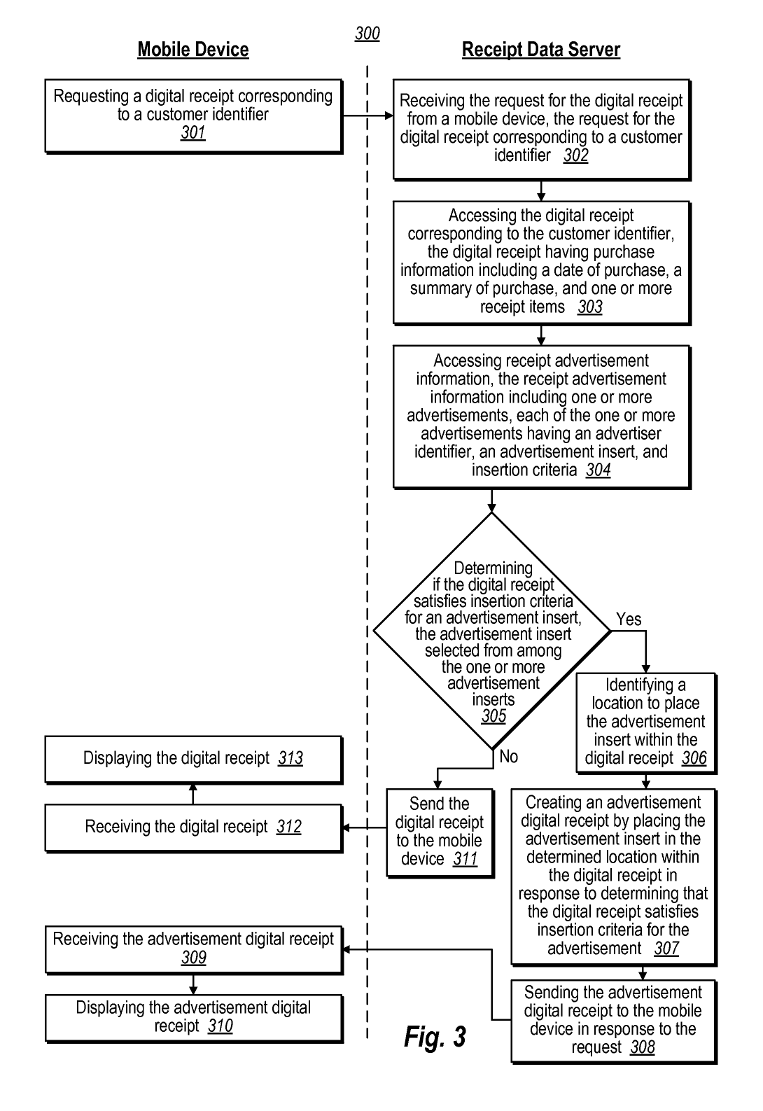

FIG. 3 illustrates a flow chart of an example method 300 for inserting advertisement content in a digital receipt. Method 300 will be described with respect to the components and data in computer architecture 200.

In general, method 300 can be used to create an advertisement digital receipt including additional advertising content for presentation at display 204.

Method 300 includes requesting a digital receipt corresponding to a customer identifier (301). For example, customer 291 can enter input 292 requesting a digital receipt. Mobile device 201 can convert input 292 into request 239, including application ID 231. Mobile device 201 can send request 239, including application ID 231, to receipt database server 221. Method 300 includes receiving a request for digital receipts from a mobile device, the request for digital receipts corresponding to a customer identifier (302). For example, receipt database server 221 can receive request 239, including application ID 231, from mobile device 201.

Method 300 includes accessing the digital receipt corresponding to the customer identifier, the digital receipt having purchase information including a date of purchase, a summary of purchase, and one or more receipt items (303). For example, data access module 263 can access digital receipt 242 including receipt items 244A, 244B, 244C, and 244D. Digital receipt data 242 can also include a date of purchase and a summary of purchase (e.g., a total price). Method 300 includes accessing receipt advertisement information, the receipt advertisement information including one or more advertisement inserts, insertion criteria, and insertion instructions (304). For example, arrangement module 207 can access advertising configuration 287. Advertising configuration 287 includes insertion criteria 266, insertion instructions 267, and advertisement inserts 284A and 284B.

Method 300 includes determining if the digital receipt satisfies insertion criteria for an advertisement insert, the advertisement insert selected from among the one or more advertisements (decision block 305). For example, insertion module 209 can determine if digital receipt 242 satisfies insertion criteria 266 for advertisement insert 284A.

If the digital receipt does not satisfy the insertion criteria (NO at decision block 305), method 300 includes sending the digital receipt to the mobile device (311). For example, receipt database server 221 can send digital receipt 242 to mobile device 201 (not shown). Method 300 includes receiving the digital receipt (312). For example, mobile device 201 can receive receipt 242 from receipt database server 221 (not shown). Method 300 includes displaying the digital receipt (313). For example, display module 210 can present advertisement digital receipt 242 within user-interface 219 at display 204 (not shown).

If the digital receipt does satisfy the insertion criteria (YES at decision block 305), method 300 includes identifying a location to place an advertisement insert within the digital receipt (306). For example, insertion module 209 can identify a location to place advertisement insert 284A within digital receipt 242.

Method 300 includes creating an advertisement digital receipt by placing the advertisement insert in the determined location within the digital receipt in response to determining that the digital receipt satisfies insertion criteria for an advertisement (307). For example, arrangement module 207 can create advertisement receipt 272 by placing advertisement insert 284A in the determined location within digital receipt 242 in response to determining that digital receipt 242 satisfies insertion criteria 266. Method 300 includes sending the advertisement digital receipt to the mobile device in response to the request (308). For example, receipt database server 221 can send advertisement receipt 272, including advertisement insert 284A, to mobile device 201.

Method 300 includes receiving the advertisement digital receipt (309). For example, mobile device 201 can receive advertisement receipt 272, including advertisement insert 284A, from receipt database server 221. Method 300 includes displaying the advertisement digital receipt (310). For example, display module 210 can present advertisement digital receipt 272 within user-interface 219 at display 204.

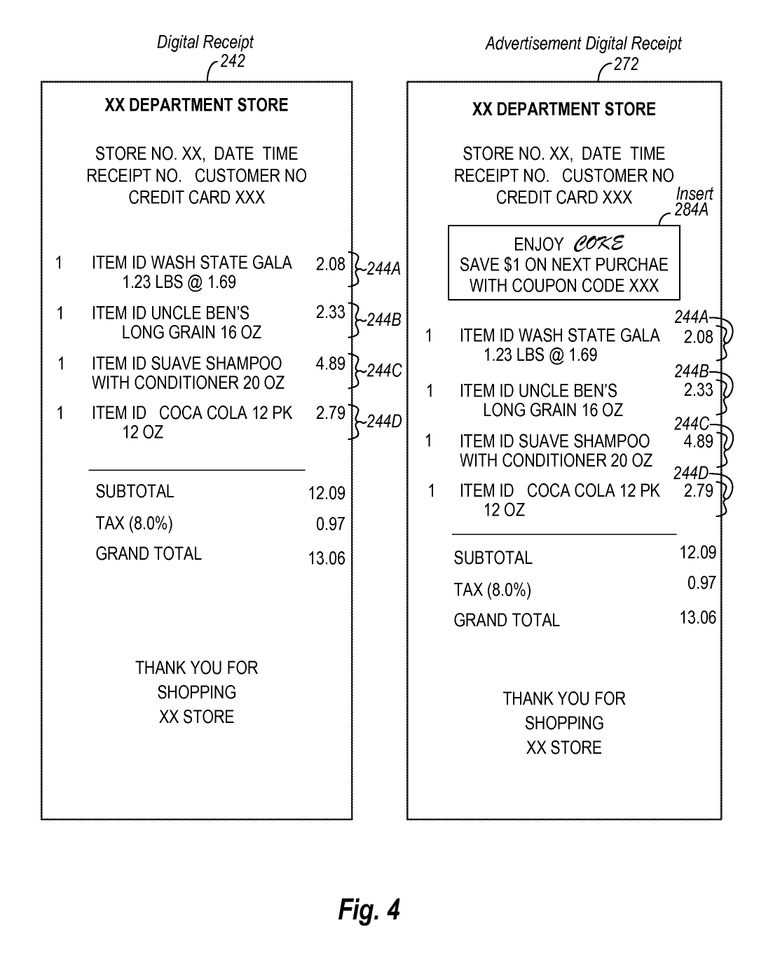

FIG. 4 illustrates an example of an advertisement digital receipt having inserted advertising content. As depicted, digital receipt 242 includes receipt items 244A, 244B, 244C, and 244D. Advertising digital receipt 272 additionally includes advertisement insert 284A placed above receipt items 244A, 244B, 244C, and 244D.

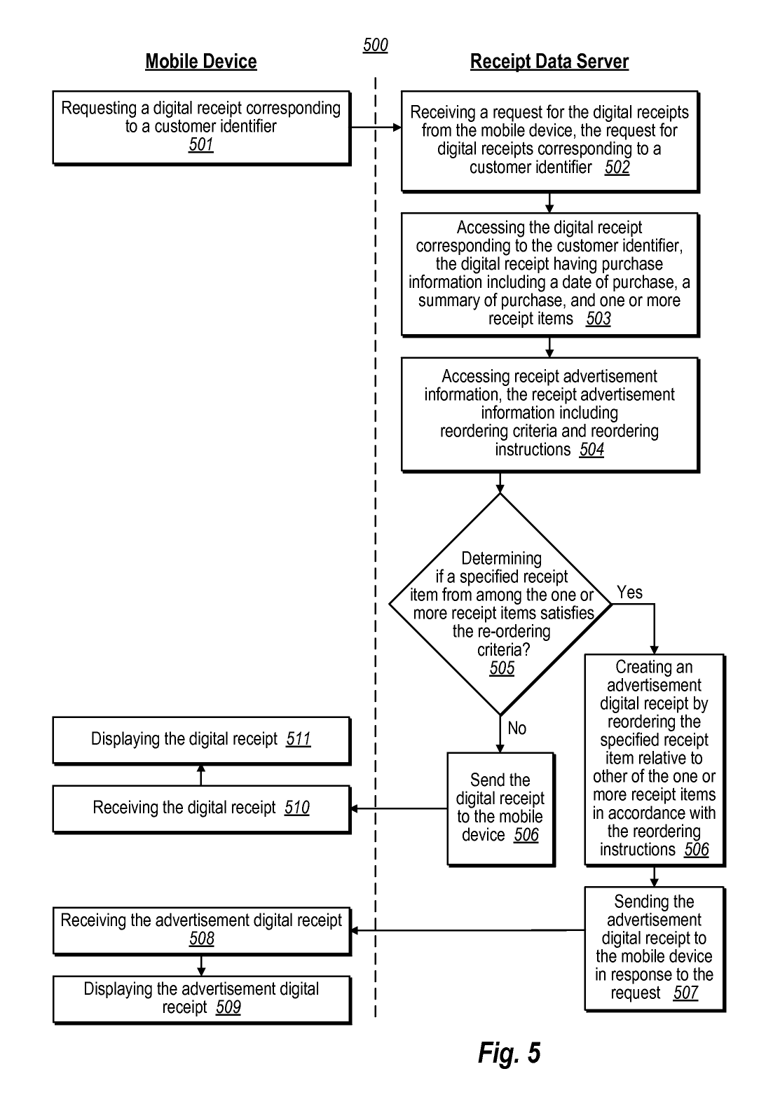

FIG. 5 illustrates a flow chart of an example method 500 for rearranging receipt items of a digital receipt for advertising. Method 500 will be described with respect to the components and data in computer architecture 200.

Method 500 includes requesting a digital receipt corresponding to a customer identifier (501). For example, customer 291 can enter input 292 requesting a digital receipt. Mobile device 201 can convert input 292 into request 239, including application ID 231. Mobile device 201 can send request 239, including application ID 231, to receipt database server 221. Method 500 includes receiving a request for digital receipts from a mobile device, the request for digital receipts corresponding to a customer identifier (502). For example, receipt database server 221 can receive request 239, including application ID 231, from mobile device 201.

Method 500 includes accessing the digital receipt corresponding to the customer identifier, the digital receipt having purchase information including a date of purchase, a summary of purchase, and one or more receipt items (503). For example, data access module 263 can access digital receipt 242 including receipt items 244A, 244B, 244C, and 244D. Digital receipt data 242 can also include a date of purchase and a summary of purchase (e.g., a total price). Method 500 includes accessing receipt advertisement information, the receipt advertisement information including reordering criteria and reordering instructions (504). For example, arrangement module 207 can access advertising configuration 287. Advertising configuration 287 includes reordering criteria 268 and reordering instructions 269.

Method 500 includes determining if a specified receipt item from among the one or more receipt items satisfies reordering criteria (decision block 505). For example, reordering module 208 can determine if receipt item 244D satisfies reordering criteria 268.

If the digital receipt does not satisfy the insertion criteria (NO at decision block 505), method 500 includes sending the digital receipt to the mobile device (510). For example, receipt database server 221 can send digital receipt 242 to mobile device 201 (not shown). Method 500 includes receiving the digital receipt (511). For example, mobile device 201 can receive receipt 242 from receipt database server 221 (not shown). Method 500 includes displaying the digital receipt (512). For example, display module 210 can present advertisement digital receipt 242 within user-interface 219 at display 204 (not shown).

If the digital receipt does satisfy the insertion criteria (YES at decision block 505), method 500 includes creating an advertisement digital receipt by reordering the specified receipt item relative to other of the one or more receipt items in accordance with the reordering instructions (506). For example, arrangement module 207 can create advertisement receipt 273 by reordering receipt item 244D relative to receipt items 244A, 244B, and 244C in accordance with reordering instructions 269. In some embodiments, receipt items 244A, 244B, 224C, and 244D are reordered from the ordering in which they were original scanned at POS system 211.

Method 500 includes sending the advertisement digital receipt to the mobile device in response to the request (507). For example, receipt database server 221 can send advertisement receipt 273, including reordered receipt item 244D, to mobile device 201.

Method 500 includes receiving the advertisement digital receipt (508). For example, mobile device 201 can receive advertisement receipt 273, including reordered receipt item 244D, from receipt database server 221. Method 500 includes displaying the advertisement digital receipt (509). For example, display module 210 can present advertisement digital receipt 273 within user-interface 219 at display 204.

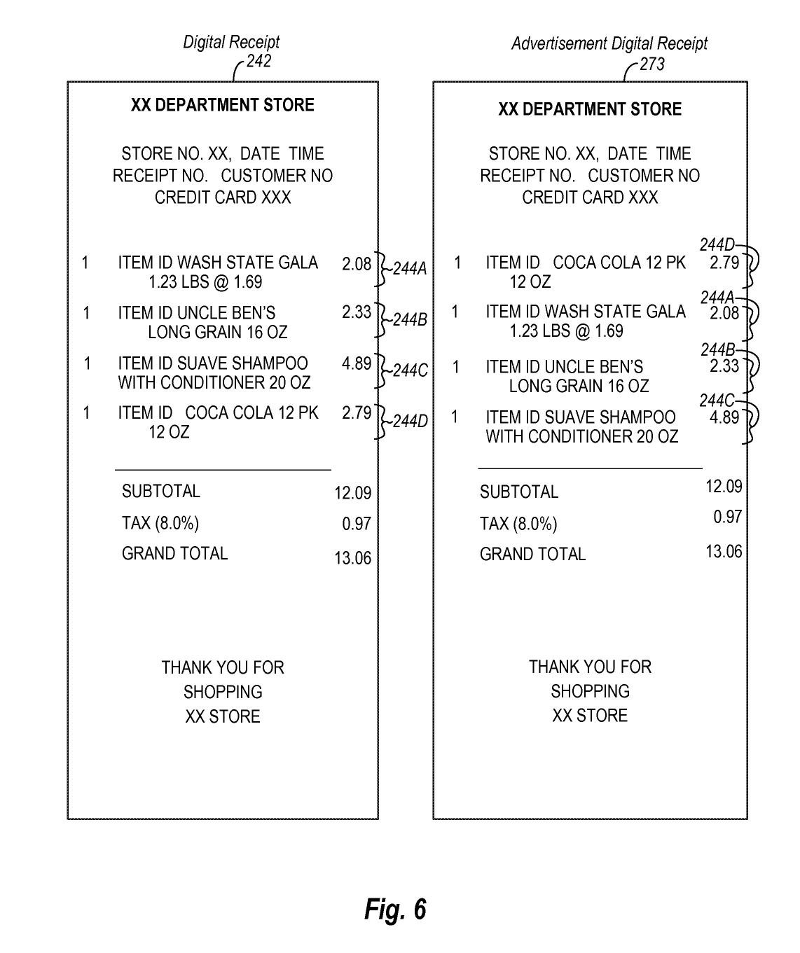

FIG. 6 illustrates an example of an advertisement digital receipt having re-arranged receipt items. As depicted, digital receipt 242 includes receipt items 244A, 244B, 244C, and 244D. In digital receipt 242, receipt item 244A is closest to the top. Receipt item 244A is followed by receipt item 244B then receipt item 244C and then receipt item 244D. Advertisement digital receipt 273 also includes receipt items 244A, 244B, 244C, and 244D. In advertisement digital receipt 273, receipt item 244D is reordered to the top. Receipt item 244D is followed by receipt item 244A then receipt item 244B and then receipt item 244C.

In further embodiments, advertisement digital receipt 273 can also include advertisement insert 284A or can include an advertisement insert for a different product.

Either of advertisement digital receipts 272 and 273 can also include public service inserts or other non-profit content.

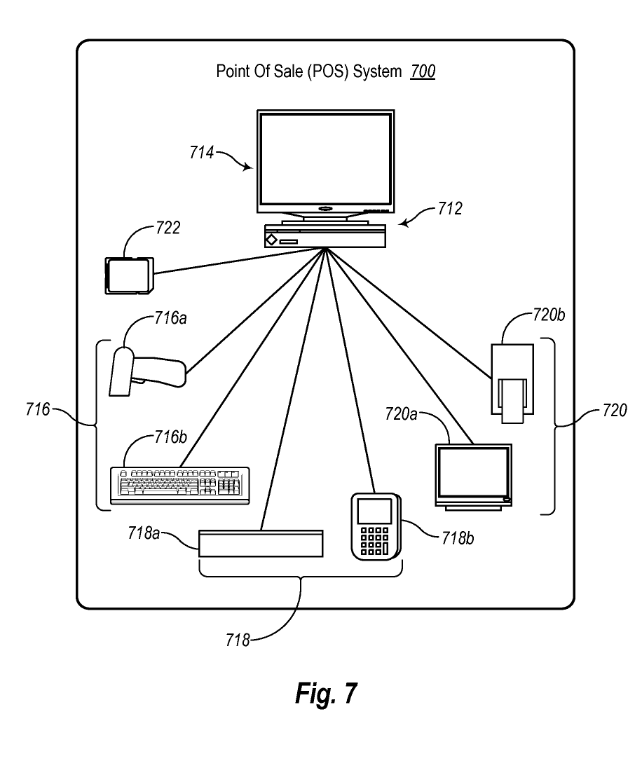

Turning to FIG. 7, FIG. 7 illustrates an example schematic block diagram of a point-of-sale (POS) system 700. In some embodiments, the hardware, software, or hardware and software of POS system 700 may be configured to implement one or more methods in accordance with the present invention. For example, POS system 700 may be manufactured, programmed, modified, or upgraded to support creating and sending digital receipt data to receipt database server 221. POS system 211 can be a POS system similar to POS system 700.

POS system 700 can include various components. In some embodiments, POS system 700 includes a central or primary computer 712, a monitor 714 (e.g., a cashier-facing monitor 714), one or more input devices 716 (e.g., scanners 716a, keyboards 716b, scales, or the like), one or more payment devices 718 (e.g., cash drawers 718a, card readers 718b) for receiving or returning payments, one or more output devices 720 (e.g., customer-facing display 720a or monitor 720a, receipt printer 720b), or the like or combinations or sub-combinations thereof, and NFC module 722, such as, for example, an NFC dongle.

Computer 712 may form the backbone of POS system 700. Other components 716, 718, 720, 722 forming part of a POS system 700 can communicate with computer 712. Input devices 516 and certain payment devices 718 can feed data and commands to computer 512 for processing or implementation. For example, scanner 716a can pass data communicating the identity of one or more items to be purchased, returned, or the like to a computer 712. Similarly, card reader 718b can pass payment information to computer 712.

On the other hand, output devices 720 and certain payment devices 718 can follow or implement commands issued by computer 712. For example, cash drawer 718a may open in accordance with the commands of computer 712. Similarly, customer-facing display 720a and receipt printer 520b can display or output data or information as instructed by computer 712.

In some embodiments, in addition to handling consumer transactions (e.g., purchases, returns), POS system 700 can provide or support certain “back office” functionality. For example, POS system 700 can provide or support inventory control, purchasing, receiving and transferring products, or the like. POS system 700 can also store sales and customer information for reporting purposes, marketing purposes, receivables management, trend analysis, cost analysis, price analysis, profit analysis, or the like. If desired or necessary, POS system 700 can include an accounting interface to pass certain information to one or more in-house or independent accounting applications.

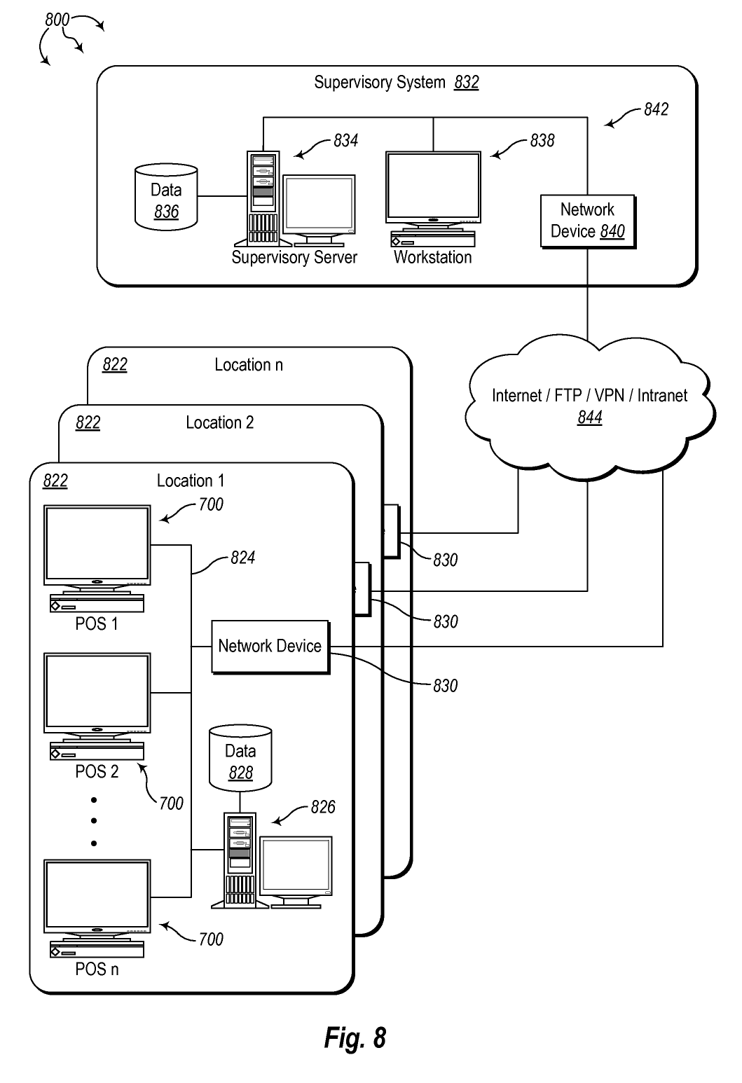

In some embodiments, POS system 700 operates substantially independently, as a stand-alone unit. Alternately, POS system 700 may be one of several POS systems 700 forming the front line of a larger system. FIG. 8 illustrates an example schematic block diagram of a network 800 of point-of-sale (POS) systems 700. For example, multiple POS systems 500 may operate at a particular location 822 (e.g., within a retail, brick-and-mortar store). In such embodiments, the various POS systems 700 may be interconnected via LAN 824. LAN 824 may also connect the POS systems 700 to a local server 826.

Local server 826 can support the operation of the associated POS systems 700. For example, a server 826 may provide a central repository from which certain data needed by the associated POS systems 700 may be stored, indexed, accessed, or the like. Server 826 can serve certain software to one or more POS systems 700. In certain embodiments, a POS system 700 can offload certain tasks, computations, verifications, or the like to server 826.

Alternatively, or in addition thereto, server 826 can support certain back office functionality. For example, server 826 can receive and compile (e.g., within an associated database 828) data from the various associated POS systems 700 to provide or support inventory control, purchasing, receiving and transferring products, or the like. Server 826 can also receive and compile sales and customer information for reporting purposes, marketing purposes, receivables management, trend analysis, cost analysis, price analysis, profit analysis, or the like.

In some embodiments, one or more POS systems 700 and/or servers 826 corresponding to a particular location 822 can communicate with or access one or more remote computers or resources via one or more network devices 830. For example, a network device 830 can enable a POS system 700 to contact outside resources and verify the payment credentials (e.g., credit card information) provided by a customer. A network device 830 can comprise a modem, router, or the like.

In selected embodiments, POS systems 700 operate within an enterprise-wide system 831 comprising multiple locations 822 (e.g., branches 822 or stores 822). In such embodiments, each location 822 may have one or more POS systems 700, local servers 826, local databases 828, network devices 830, or the like or combinations or sub-combinations thereof connected by a computer network (e.g., a LAN 824). Any of local servers 826 can include the functionality receipt database server 221. Thus, any of local servers 826 can be configured to arrange advertising content in digital receipts.

Additionally, each such location 822 may be configured to interact with one or more supervisory systems 832. For example, multiple branch locations 822 may report to an associated “headquarters” location or system.

A supervisory system 832 can include one or more supervisory servers 834, databases 836, workstations 838, network devices 840, or the like or combinations or sub-combinations thereof. The various components of a supervisory system 832 can be interconnected via a computer network (e.g., a LAN 842). In selected embodiments, a supervisory system 832 includes one or more supervisory servers 834 providing a central repository from which certain data needed by the one or more POS systems 700 or local servers 826 may be stored, indexed, accessed, or the like. Any of supervisory servers 834 can include the functionality receipt database server 221. Thus, any of supervisory servers 834 can be configured to arrange advertising content in digital receipts.

Alternatively, or in addition thereto, a supervisory server 834 can receive and compile (e.g., within an associated database 836) data from the various associated POS systems 700 or local servers 826 to provide or support inventory control, purchasing, receiving and transferring products, or the like. A supervisory server 834 may also receive and compile sales and customer information for reporting purposes, marketing purposes, receivables management, trend analysis, cost analysis, price analysis, profit analysis, or the like.

A supervisory system 832 can be connected to one or more associated locations 822 or branches 822 in via any suitable computer network 844 (e.g., WAN 844). For example, in selected embodiments, one or more locations 822 can connect to a supervisor system 832 via the Internet. Communication over such a network 844 can follow any suitable protocol or security scheme. For example, communication may utilize the File Transfer Protocol (FTP), a virtual private network (VPN), intranet, or the like.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a receipt database server, the receipt database server including a processor, system memory, and one or more storage devices, a method for inserting advertisement content into a digital receipt, the method comprising:
receiving a request for digital receipts from a mobile device, the request for digital receipts corresponding to a customer identifier;
accessing a digital receipt corresponding to the customer identifier, the digital receipt having purchase information including a date of purchase, a summary of purchase, and one or more receipt items;
accessing receipt advertisement information, the receipt advertisement information including one or more an advertisement inserts, insertion criteria, and insertion instructions;
determining that the digital receipt satisfies insertion criteria for an advertisement insert, the advertisement insert selected from among the one or more advertisement inserts;
identifying a location to place the advertisement insert within the digital receipt;
creating an advertisement digital receipt by placing the advertisement insert in the determined location within the digital receipt in response to determining that the digital receipt satisfies insertion criteria for an advertisement; and
sending the advertisement digital receipt to a mobile device in response to the request.

2. The method of claim 1, wherein identifying a location to place the advertisement insert within the digital receipt comprises identifying a location near the top of the digital receipt.

3. The method of claim 1, wherein the summary of purchase includes a total payment for purchased items and an insertion criterion requires the total payment to exceed a specified threshold.

4. The method of claim 1, wherein creating an advertisement digital receipt by placing the advertisement insert in the determined location within the digital receipt comprises creating a digital receipt by placing one or more of: textual data and graphical data in the digital receipt.

5. The method of claim 1, wherein creating an advertisement digital receipt by placing the advertisement insert in the determined location within the digital receipt comprises creating a digital receipt by placing supplemental content in the digital receipt, the supplemental content modifying the display characteristics of a receipt item.

6. The method of claim 5, wherein creating a digital receipt by placing supplemental content in the digital receipt comprises placing supplemental content that highlights or changes the display color of the receipt item to increase the prominence of the receipt item when displayed.

7. The method of claim 1, wherein determining that the digital receipt satisfies insertion criteria for an advertisement insert comprises determining that the advertisement insert has been inserted into digital receipts less than a threshold number of times.

8. The method of claim 1, wherein determining that the digital receipt satisfies insertion criteria for an advertisement insert comprises determining that a user of the mobile device has opted in for advertisements.

9. At a receipt database server, the receipt database server including a processor, system memory, and one or more storage devices, a method for rearranging receipt items of a digital receipt for advertising, the method comprising:
receiving a request for digital receipts from a mobile device, the request for digital receipts corresponding to a customer identifier;
accessing a digital receipt corresponding to the customer identifier, the digital receipt having purchase information including a date of purchase, a summary of purchase, and one or more receipt items;
accessing receipt advertisement information, the receipt advertisement information including reordering criteria and reordering instructions;
determining that a specified receipt item from among the one or more receipt items satisfies reordering criteria;
creating an advertisement digital receipt by reordering the specified receipt item relative to other of the one or more receipt items in accordance with the reordering instructions; and
sending the advertisement digital receipt to a mobile device, in response to the request.

10. The method of claim 9, wherein the summary of purchase includes a total payment for purchased items and a reordering criterion requires the total payment to exceed a specified threshold.

11. The method of claim 9, wherein creating an advertisement digital receipt by reordering the specified receipt item relative to other of the one or more receipt items comprises creating an advertisement digital receipt by reordering the specific receipt item closer to the top of the digital receipt in accordance with the reordering instructions.

12. The method of claim 9, wherein determining that the digital receipt satisfies reordering criteria for an advertisement insert comprises determining that a user of the mobile device has opted in for advertisements.

13. The method of claim 9, wherein creating an advertisement digital receipt further comprising placing an advertisement insert in a determined location within the digital receipt.

14. The method claim 13, wherein placing an advertisement insert in a determined location within the digital receipt comprises placing one or more of: textual data and graphical data in the digital receipt.

15. A computer system having a processor, system memory, and a display, the system comprising:
a communication module configured to receive requests for digital receipts and return digital receipts to requesting devices, wherein digital receipts are associated with a an application ID and digital receipts include receipt items;
a storage device for storing digital receipts and for storing advertisement configurations, the advertisement configurations including: one or more advertisement inserts, insertion criteria, insertion instructions, reordering criteria, and reordering instructions; and
an arrangement module, the arrangement module configured to:
reorder receipt items within digital receipts in accordance with the reordering instructions in response to satisfying the reordering criteria; and
place advertisement inserts within digital receipts in accordance with the insertion instructions in response to satisfying the insertion criteria.

16. The computer system of claim 15, wherein the arrangement module is further configured to place supplemental content within digital receipts in accordance with the insertion instructions in response to satisfying the insertion criteria, the supplemental content modifying the display characteristics of a receipt item.

17. The computer system of claim 16, wherein the arrangement module being configured to place supplemental content within digital receipts in accordance with the insertion instructions comprises the arrangement module being configured to place supplemental content that highlights or changes the display color of the receipt item to increase the prominence of the receipt item when displayed.

18. The computer system of claim 15, wherein the arrangement module being configured to place advertisement inserts within digital receipts comprises the arrangement module being configured to place one or more of: textual data, graphics, hyperlinks within digital receipts, and triggers to launch customer workflows.

19. The computer system of claim 15, wherein the arrangement module being configured to place advertisement inserts within digital receipts comprises the arrangement module being configured to place public service announcements within digital receipts.

20. The computer system of claim 15, wherein the arrangement module being configured to reorder receipt items within digital receipts comprises the arrangement module being configured to reorder receipt items closer to the top of the digital receipts in accordance with the reordering instructions.
